(19) United States
(12) Patent Application Publication
(10) Pub. No.: US 2009/0202213 A1
(43) Pub. Date: Aug. 13, 2009

(54) Routing Device for Optical Fibre Systems

(76) Inventors: Ian Griffiths, Hampshire (GB); Paul Hubbard, Hampshire (GB); Malcolm Jones, Hampshire (GB)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/224,174

(22) PCT Filed: Feb. 22, 2006
(86) PCT No.: PCT/GB2006/000630

§ 371 Date: Dec. 3, 2008

(51) Int. Cl. G02B 6/00

(52) U.S. Cl. 385/135

(57) ABSTRACT

A routing device is provided for use in optical systems for routing and distributing optical fibres within optical networks, optical hardware, and optical joints thereof. The routing device includes a plurality of cable ports for receiving one or more cable elements, which include one or more optical fibres. Each of a plurality of guiding tracks is connected to at least one cable port, and one or more output ports in which the optical fibres are routed from the cable ports to the output ports. An optical joint for use in optical systems includes, one or more trays and at least one routing device mounted within the optical joint. The optical joint receives the one or more cable elements, which are plugged into the routing device and routes the one or more optical fibres through the routing device to distribute them from at least one of the output ports to their respective trays.

### FIELD OF THE INVENTION

The present invention relates to a routing device for use in optical systems. In particular, it relates to the routing and distribution of optical fibres in optical networks, optical hardware, and optical joints thereof.

### BACKGROUND

Optical communication systems require the laying down of numerous optical cables and fibres. These are connected to various forms of optical fibre hardware such as optical joints, e.g. optical fibre closures or splicing enclosures. Optical joints are used for managing optical cable and fibre connections and storage and provide a point in which optical fibres are spliced or stored and sealed from the environment.

Typically, optical joints receive a plurality of optical cables, each in turn having at least one optical fibre. This generally causes congestion of the optical joints due to intertwining of the optical cables and/or of the optical fibres. As more optical cables and fibres are connected to an optical communication system, cable management, e.g. within the optical joints, becomes evermore difficult.

Traditionally, optical cables are distributed throughout optical joints and, as more cables are installed, there is an increased likelihood of optical fibre damage as bending the optical cable and fibres around each other risks bending beyond their minimum bend radius. Alternatively, the optical fibres can be split-out of the optical cable and a flexible tube, called a transport tube, can be used to protect and distribute the optical fibres throughout the optical joint, said transport tube fitting over the optical cable and splitting-out the optical fibres. Although this may temporarily alleviate congestion, as the transport tubes are more flexible than optical cables, the problem of excessive congestion and damage to optical fibres still persists as more and more optical cables are required in the optical joint.

Several solutions attempt to alleviate optical fibre damage by guiding the optical cables or transport tubes within optical fibre cable trays for use in optical joints as described, for instance, in U.S. Pat. No. 6,311,007 B1. The trays allow changes in length of an optical cable to be accommodated by winding the cables around various adjustable guides on the tray, with the guides being placed to ensure that the optical cable is not bent beyond its minimum bend radius. However, there is no consideration for controlling how the optical cables or transport tubes are distributed from their point of entry in the optical joint to their corresponding trays. It is this lack of control that leads to further damage of the optical cables and fibres within the optical joint during installation and maintenance.

An alternative attempt at protecting optical fibres within an optical joint is provided by a shield bond strain connector as described in U.S. Pat. No. 5,617,501. Fibre optic telecommunications cables, with outer jackets surrounding the strength members and optical fibres, are secured through one of many cable ports of the shield bond strain connector. The strength members of these cables are secured with clamping elements providing a form of strain relief, from external forces to the optical joint.

Once these cables are secured, the optical cables within are distributed throughout the optical joint to various trays for splicing and/or storage. Only when the optical cables reach their required trays are the numerous optical fibres routed onto or between the trays. In the latter case, removable split tubes are used to hold the optical fibres for protection. However, again there is no consideration for controlling the distribution of optical cables throughout the optical joint. This again leads to damage of the optical cables and fibres (not within the trays) between the point of entry and the trays when the optical joint is opened or the trays are moved during installation and maintenance.

In general, as optical cables and/or transport tubes are installed and maintained within, for instance, optical joints, they will crossover or intertwine. This results in the cables being bent or twisted around other cables or transport tubes within the optical joint as they are distributed to their respective trays. The optical cables and/or transportation tubes are then at risk of being bent beyond their minimum bend radius. Faults or breakages of the optical fibre result. These may not even be detected until several years after the damage has occurred, requiring expensive repair or re-installation costs for the affected optical cables and fibres, or a loss in optical fibre capacity.

The significant congestion of optical cables or transport tubes within optical joints is becoming a problem as the number of trays and/or optical cables is remarkably increasing. The Applicant has noted that currently there is no control in the way optical cables and fibres are routed and distributed throughout optical joints and other optical hardware systems. The Applicant has thus perceived the need of improving optical cable management in the optical hardware systems in order to reduce the increasing likelihood of accidental faults and/or breakages of the optical fibres during installation and maintenance of the optical joints and optical cables therein.

### SUMMARY OF THE INVENTION

The Applicant has found that controlling the routing and distribution of optical fibres at an early stage in an optical hardware system, e.g. in an optical joint, can minimise congestion of cable elements, such as optical cables or transport tubes, and prevents, among other things, the above-mentioned optical fibre faults.

In one aspect, the invention relates to a routing device for use in optical systems. The routing device includes a plurality of cable ports for at least partially receiving one or more cable elements, where the cable elements include one or more optical fibres. In addition, a plurality of guiding tracks are connected to at least one of the cable ports and one or more output ports are connected to at least one of the guiding tracks. The guiding tracks route the one or more optical fibres from their respective cable ports to the one or more output ports for further distribution of the optical fibres.

In other words, the invention avoids, or at least remarkably reduces, the congestion caused by the routing systems known in the art according to which the cable elements are routed to the splicing trays (in the case an optical joint is considered, for instance) and thus guided directly at the entrance of the splicing trays. The Applicant has in fact perceived that the solutions known in the art do not provide any control of the cable elements between the entry port of the joint and the entrance to the tray, this aspect being left to the installers discretion and possibly leading to congestion as well as poor routing below the minimum bend radius. The Applicant has thus found a fibre routing system which allows the cable elements to be straightly and neatly routed to the inlet of a routing device inside of which the optical fibres, contained within the cable elements, are guided to a common port and then to their respective splicing trays.

According to the invention the reduction in congestion of the cable elements within an optical hardware system, such as an optical joint, is achieved by controlling where the cable elements are routed and distributed to. Namely, according to the invention, the cable elements are routed to the routing device where they are received by the cable ports, which are positioned at the entrance of the routing device. At the cable ports the optical fibres, contained in the cable elements, are routed through the routing device. The routing device can be arranged such that the cable elements are routed to the routing device from their point of entry into the optical hardware system instead of being routed directly to within the optical hardware system, i.e. to their respective splicing trays.

In another aspect, the invention relates to a routing device for use in optical systems that includes a plurality of cable ports for at least partially receiving one or more cable elements, a plurality of guiding tracks, each connected to at least one of the cable ports, and one or more output ports, where two or more of the guiding tracks connect with one of the output ports.

In a further aspect, the invention relates to a routing device for use in optical systems that includes a plurality of cable ports for at least partially receiving one or more cable elements, a plurality of guiding tracks, each connected to at least one of the cable ports, in which the cable ports further include at least one gripping portion for gripping the cable elements so that they are substantially straight in the region of the cable ports.

According to the invention, a set of optical fibres is routed through at least one common output port where the optical fibres are distributed, this aspect improving the management of the optical fibres within the optical joint since, during installation, the cable elements are plugged securely into the cable ports and the optical fibres are split-out and laid into/onto the guiding tracks. In particular, the cable elements are gripped substantially straight in the region of the cable ports, fact which in turn protects the optical fibres from damage. The result is a reduction in the number of faults in the optical fibres due to the decreased congestion of the cable elements within the optical hardware system and improved guidance and organisation of the cable elements and optical fibres within the optical joint.

According to a preferred embodiment of the invention, one or more holding portions are arranged on one or more guiding tracks to hold the optical fibres within their respective guiding tracks. This prevents the optical fibres from springing out of their respective guiding tracks during installation, use, and maintenance. According to a further preferred embodiment, the holding portions further include one or more tabs to hold the optical fibres within their respective guiding tracks. This embodiment provides the advantage of quick installation of the optical fibres within the optical joint as the fibres are simply guided around the tabs into their respective guiding tracks, as the fibre straightens out, the tabs prevent the fibres from springing out of the routing device.

Alternatively, the holding portions may be caps or covers fitted to the routing device to cover one or more guiding tracks. Alternatively, the guiding tracks or the holding portions are made up of split tubes or portions thereof, which are secured on the routing device. The split tubes can be made of elastomeric material having a seam, which may be interlocking, that can be split open to allow insertion of optical fibres and when released the seam closes (or locks) thus holding the optical fibres within. Similarly, the holding portion includes the seam, arranged over one or more guiding tracks, which can be split open or closed as one or more of the optical fibres are inserted into the guiding tracks.

In a preferred embodiment, two or more of the guiding tracks connect with at least one output port. This provides the advantage of allowing the optical fibres from multiple cable elements to be routed from their respective guiding tracks to a common output point for further distribution of the optical fibre within the optical hardware, e.g. within an optical joint.

In a preferred embodiment of the invention, the cable elements are designed to engage the cable ports, and the guiding tracks are designed to route the optical fibres, which are split-out of the cable elements.

According to a preferred embodiment, the cable elements further include one or more tube elements that fit over at least one cable element, and thus the optical fibres contained therein. Preferably, the fitting of the tube elements over the cable element is a sealed fitting which prevents the ingress of water into the routing device and onto the optical fibres thus avoiding any water damage thereto. The cable elements can be optical fibre cables allowing the direct installation of an optical fibre cable and its respective optical fibres into the routing device without any further jackets or transport tubes. Typically, the cable elements may include an elastomeric material allowing them to be easily inserted and gripped by the cable ports without permanent deformation.

In a preferred embodiment of the invention, the cable ports include one or more gripping portions for gripping the cable elements. This technical solution reduces the pull on the optical fibres and slippage of the cable element from the cable port which can be due to gravity or stresses/strains on the cable element. According to a further preferred embodiment of the invention, the gripping portions include barbs facing inward of their respective cable ports and/or ribs and the like within one or more of the cable ports, i.e. over the inner surface of one or more of the cable ports. These elements are easily mouldable and do not require any moving parts, such as screws or fixing plates, to provide a secure engagement of the cable elements into their respective cable ports in the routing device.

In another preferred embodiment of the invention, the cable elements are held substantially straight before the entrance of their respective cable ports. This prevents the cable element from bending the optical fibres below their minimum bend radius thus protecting the optical fibres within the cable element from damage.

In another preferred embodiment of the invention, the guiding tracks have a width that is less than the lateral width of one or more of the cable ports at their connection to the cable ports. This provides the advantage of plugging the cable elements up to a shoulder giving a more compact routing device as only the optical fibres are routed and distributed. Moreover, the shoulder provides protection to the optical fibres that are routed within the routing device since this shoulder prevents the cable elements from being pushed further into the guiding tracks. In fact, if they could move further into the guiding tracks, the cable elements could push on the split-out optical fibres within the guiding tracks risking damage to the optical fibres such as bending or buckling thereof.

In another preferred embodiment of the invention, at least two of the guiding tracks merge together to form a guiding track having a lateral width larger than one of the at least two guiding tracks that merged. This provides for optical fibres from one or more cable elements, which are plugged into at least one of the cable ports, to be routed along similar paths of guiding track and in most cases having the same guiding track route the optical fibre towards a common output port for distribution. The capacity of the guiding tracks can increase as other guiding tracks merge in order to handle the higher volume of optical fibres from those merging guiding tracks. In addition, the area of the routing device taken up by the guiding tracks is more efficiently used when the guiding tracks are able to merge. There is also no necessity for each guiding track to individually connect with an output port as the merged guiding tracks can continue on to connect with the output ports.

In a preferred embodiment of the invention, the routing device further includes one or more of the guiding tracks being curved between their respective cable ports and at least one of the output ports. This provides the advantage of protecting the optical fibre from sharp corners. According to said embodiment, the curved portions of the guiding tracks are provided with a bend radius higher than the optical fibre minimum bend radius.

In a preferred embodiment, the cable ports are arranged in a line or a plurality of parallel lines. This provides an organised layout and placement of the cable ports on the routing device allowing improved cable management of the cable elements and thus reducing the congestion of the cable elements.

According to a further aspect, the invention relates to a method for routing optical fibres in an optical system using at least one routing device. The method includes splitting out one or more optical fibres from one or more cable elements and inserting one or more cable elements into at least one cable port. One or more of the split-out optical fibres are positioned within one or more guiding tracks which are connected to the at least one cable port. The one or more split-out optical fibres are guided from the at least one cable port along the corresponding guiding tracks that are connected to at least one of the output ports for further distribution of the split-out optical fibres.

According to the method of the invention, installation, organisation and distribution of the optical fibres within an optical system are advantageously improved and reduction of cable elements congestion within an optical hardware system is advantageously achieved.

In a preferred embodiment of the invention, the split-out optical fibres are guided within their corresponding guiding tracks such that the split-out optical fibres are positioned to allow one or more holding portions to hold the split-out optical fibres within the guiding tracks. This provides for improved installation of the split-out optical fibres, as they are prevented from springing out of the guiding tracks as the split-out optical fibres are installed into the corresponding guiding tracks.

In another preferred embodiment, when at least one of the holding portions is a tab, then the corresponding split-out optical fibres are positioned under the tab. According to such embodiment, quick installation of the split-out optical fibres within the routing device can be obtained since the optical fibres are simply guided around the tabs into their respective guiding tracks and, as the fibres straighten out, the tabs prevent the fibres from springing out of the routing device.

According to a further embodiment of the invention, at least one of the split-out optical fibres is positioned adjacent to a previously positioned split-out optical fibre. The split-out optical fibres can be neatly organised by stacking or layered upon or beside each other within the guiding tracks providing improved access and protection of the split-out optical fibres so that they do not intertwine with each other preventing damage during accessing the split-out optical fibres within the routing device.

In another aspect, the invention relates to an optical joint for use in optical fibre systems. The optical joint includes one or more trays, and at least one routing device mounted within the optical joint.

In a preferred embodiment of the invention, at least one of the routing devices is arranged within the optical joint such that the one or more cable elements are held substantially straight between at least one of the cable ports of at least one of the arranged routing devices and at least one entrance for the cable elements to the optical joint. It is preferred that at least one of the routing devices is arranged and/or mounted substantially adjacent to at least one entrance for receiving the one or more cable elements into the optical joint. In such a way the cable elements are directly routed to the routing device, thus minimising the congestion of the cable elements within the optical joint. Moreover, the optical joint according to the invention allows to efficiently use the space therein and to reduce the wear and tear on the cable elements and optical fibres thanks to the fact that the routing device prevents movement of the cable elements as the trays are opened and closed.

According to the invention an improved cable management of the cable elements is obtained thanks to the fact that the cable elements are held substantially straight between the cable ports of the arranged routing device and the entrance from where they enter the optical joint. By ensuring the cable elements are substantially straight, the optical fibres within the cable elements are also, in turn, held substantially straight. This further protects the optical fibres and cable elements from damage caused by intertwining cable elements or by bending the cable elements beyond their minimum bend radius as they are installed within the optical joint.

According to a further embodiment of the invention, the trays overlap each other so that the space within the optical joint is advantageously minimised. Preferably, the trays are hingedly or pivotally mounted within the optical joint so as to improve the access to the current tray from above and/or from below. At least one of the trays may be a splicing tray.

Preferably, the optical joint is weatherproofed by providing an optical joint cap or cover, which may be domed, or shaped to accommodate the trays, routing device/s, a portion of optical cables and fibres and other components of the optical joint. These covers can be used to seal the trays, optical cables, and optical fibres from the environment, particularly from water. The optical joint cover can be secured to the optical joint by a securing mechanism, e.g. a screw thread, latches or clips, where the optical joint and/or cover are sealed with a waterproof sealant such as a silicon based sealant.

The trays and/or routing devices can be mounted to the optical joint using snap-fit joints, latches or any other securing means. Snap-fit joints or latches are advantageous as they allow additional trays and/or routing devices to be quickly installed to the optical joint when needed. Alternatively, a more secure mounting mechanism may be required, such as screws or bolts, which can prevent accidental removal of the routing device due to possible strains on the cable elements.

### BRIEF DESCRIPTION OF THE DRAWINGS

Preferred features of the invention will now be described, purely by way of example, with reference to the accompanying drawings, in which:—

FIG. 1a illustrates perspective views of an embodiment of the invention for use in optical systems.

FIG. 1b illustrates a plan elevation, top elevation, front elevation and side elevation of the embodiment of the invention illustrated in FIG. 1a.

FIG. 1c illustrates a plan elevation, front elevation and side elevation of a further embodiment of the invention.

FIG. 2a illustrates a perspective view of an embodiment of an optical joint that uses the embodiment of the invention illustrated in FIGS. 1a and 1b.

FIG. 2b illustrates a plan elevation, side elevation, and front elevation of the embodiment of the optical joint of FIG. 2a.

FIG. 2c illustrates a perspective view of a cap for the embodiment of the optical joint illustrated in FIGS. 2a and 2b.

FIG. 3 illustrates a perspective view of an embodiment of an optical joint that uses the embodiment of the invention of FIG. 1c.

FIG. 4 illustrates a front elevation of elongated cable ports of a further embodiment of the invention.

### DETAILED DESCRIPTION OF THE PREFERRED EMBODIMENTS

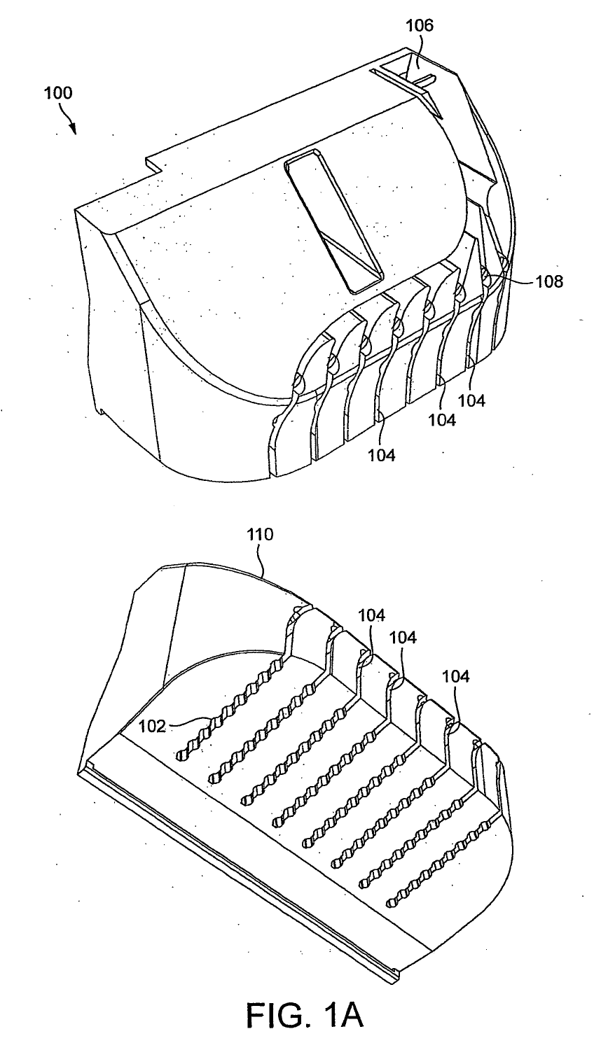

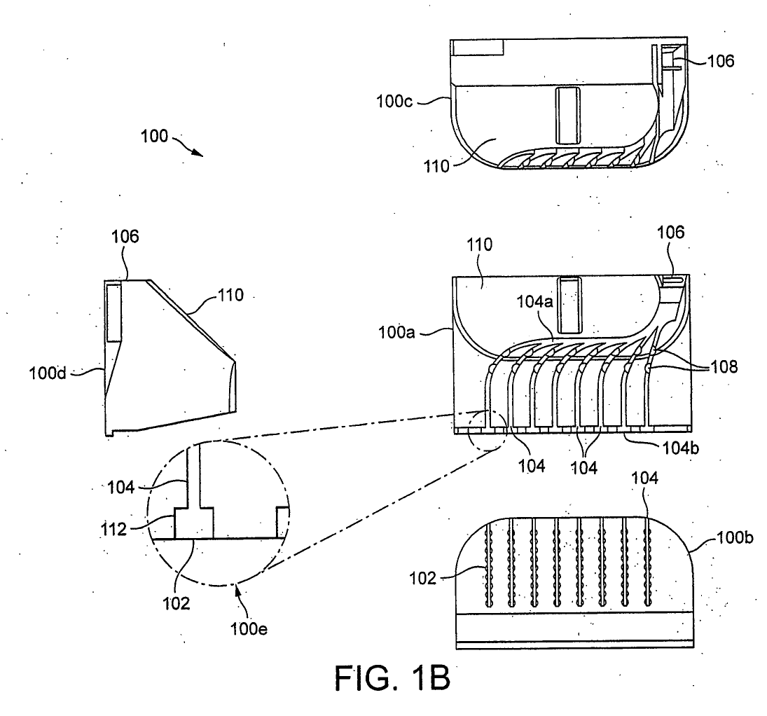

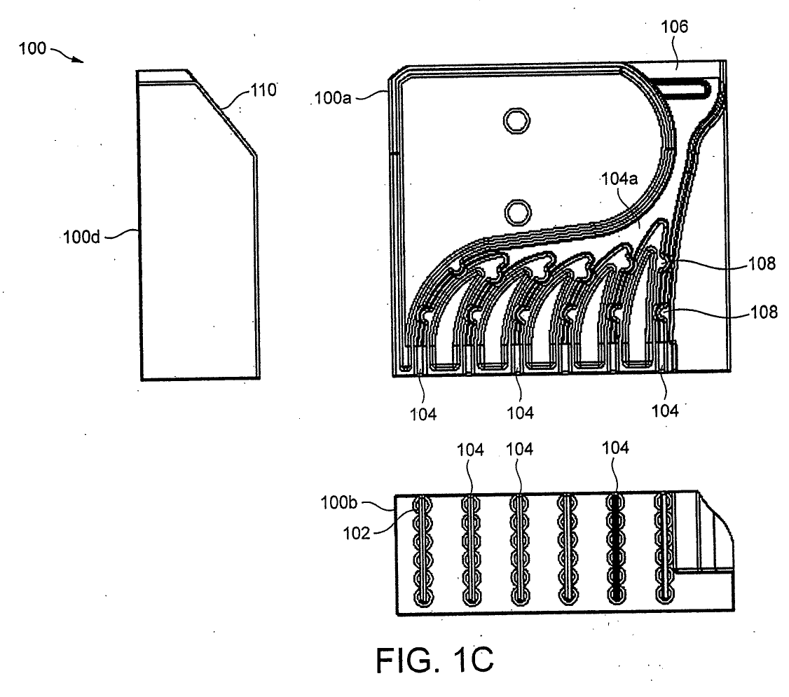

Two perspective views of a routing device 100 for routing and distributing optical fibres in an optical system is shown in FIG. 1a A plan elevation 100a, front elevation 100b, back elevation 100c, and side elevation 100d of the routing device 100 is shown in FIG. 1b. In addition, a plan elevation 100a, front elevation 100b, and side elevation 100d of a further arrangement of the routing device 100 is also shown in FIG. 1c.

Referring to FIGS. 1a, 1b and 1c, a brief overview of the routing device 100 is now given followed by a detailed description of its components and use. The routing device 100 includes a plurality of cable ports 102 that are connected to a plurality of guiding tracks 104, which connect from the cable ports 102 to an output port 106. Tabs 108 are included on the routing device 100, and are located on and/or partially over the guiding tracks 104.

The routing device 100 provides a means for routing and distributing optical fibres in an optical system, such as an optical joint (to be discussed later in detail). As shown on the front and plan elevations 100a and 100b, the guiding tracks 104 form a set of grooves (or channels) over the routing device 100. These grooves will route optical fibres from the front of the routing device to the back of the routing device as seen in the front, plan and back elevations 100b, 100a and 100c. The depth of each of the guiding tracks 104 can be determined by the number of optical cables (or cable ports 102) that are required to be inserted into the routing device 100. In this example, there are eight guiding tracks 104, each having nine suitably spaced cable ports 102.

Referring to the side elevation 100b of the routing device 100 of FIGS. 1b and 1c, the plurality of cable ports 102 have a circular shape in which their diameters (or widths) are of a size that can grip a portion of the outer jacket and/or shielding of a cable element such as an optical cable or transport tube. The gripping of the optical cable/transport tube can be achieved by barbs (not shown in the figures) facing inwardly towards the guiding tracks 104. Alternatively, ribs or spikes and the like (not shown in the figures) are used for gripping the optical cable/transport tubes. The cable ports 102 connect with the guiding tracks 104 at a shoulder 112 (as seen in the magnified view 100e of FIG. 1b). Due to the size of the optical fibres, the guiding tracks 104 have a width that is smaller than the width of the cable ports 102.

Referring to the plan elevation 100a of the routing device 100 shown in FIGS. 1b and 1c, it can be noted that, preferably, the guiding tracks 104 have arcuate (curved) sections that route the optical fibres towards the output port 106. The arcuate sections are designed such that the optical fibres are not bent beyond their minimum bend radius. For example, in current industry practice it is preferred that optical fibres have a minimum bend radius of approximately 30 mm.

As the guiding tracks 104 route the optical fibres to the output port 106 they merge together forming a guiding track 104a that increases in capacity to accommodate the optical fibres that are being routed towards the output port 106 that collects the optical fibres for further distribution.

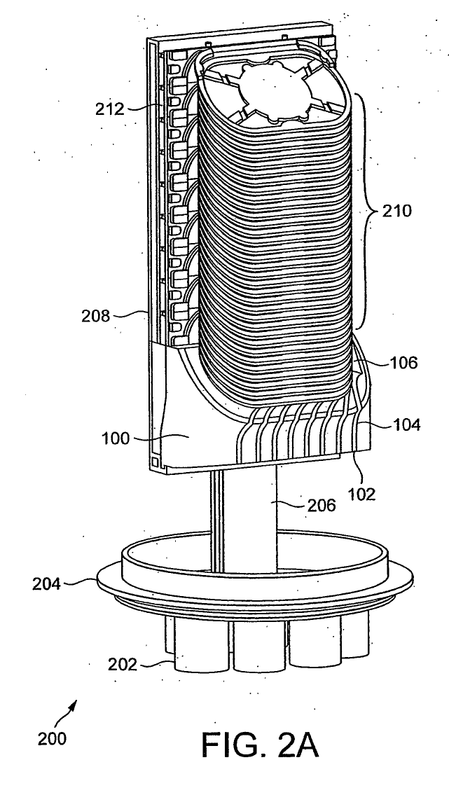

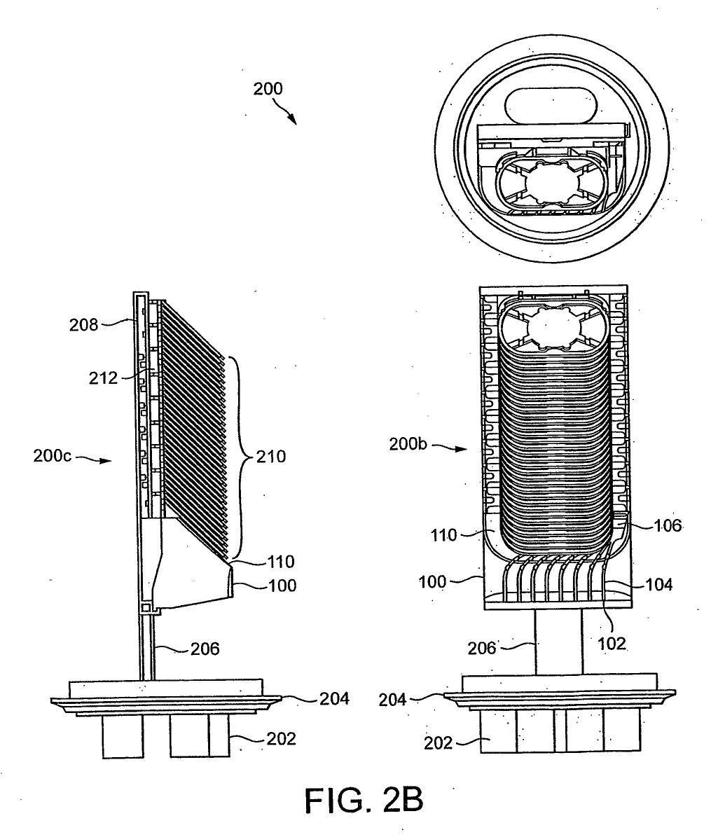

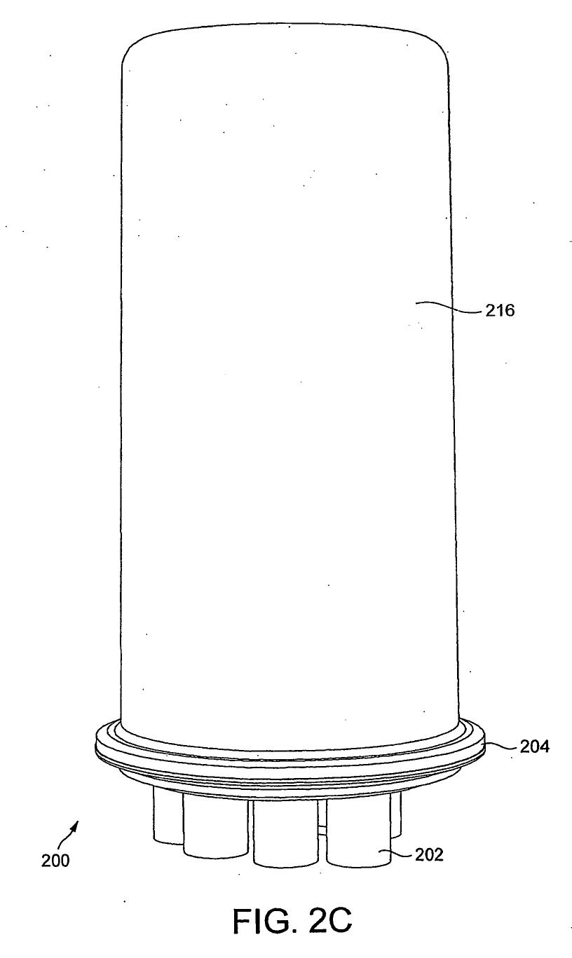

Referring to FIGS. 2a and 2b, an optical joint 200 is shown, the latter being provided with the routing device 100 described above. The routing device 100 routes the optical fibres through to its output port 106, from which the optical fibres are distributed throughout the optical joint 200—e.g. for splicing or storage—within trays 210.

Optical fibres are routed within the routing device 100 by initially splitting out the optical fibres from each cable element. The length of optical fibre that is split out from the cable element is determined by the length required to route and distribute the optical fibre from the routing device 100 to the corresponding trays 210. A portion of the cable element is inserted or plugged into one of the cable ports 102. The cable ports 102 are of a size and shape that grip the cable element (this may involve squeezing the cable element). Plugging the cable elements into the cable ports 102 reduces the wear and tear on the cable elements, and thus on the optical fibres, since the routing device 100 prevents movement thereof when trays 210 are opened and/or closed.

Each optical fibre is laid into the corresponding guiding tracks 104 and through to the output port 106. In laying down the optical fibres, they are moved around and under the corresponding tabs 108 of the guiding track 104. The tabs 108 hold the optical fibres within the guiding track 104 once installation is complete so that the optical fibres do not spill out of the guiding tracks 104.

Referring to FIG. 2b as well as to plan elevation 100d of FIGS. 1b and 1c, the routing device 100 is provided with an inclined facet 110 which cuts into the guiding tracks 104. The inclined facet 110, when the routing device 100 is mounted within an optical joint 200 (see FIGS. 2a and 2b) with trays 210 that pivot or are hinged, maximises the number of hinged trays 210 within the optical joint 200, and minimises the size of the optical joint 200 by allowing the trays 210 to be stored in an inclined position.

A perspective view of an optical joint 200 is shown in FIG. 2a, said optical joint being provided with the routing device 100 illustrated in FIGS. 1a and 1b. The plan elevation 200a, front elevation 200b, and side elevation 200c of the optical joint 200 are shown in FIG. 2b. Referring to FIGS. 2a and 2b, an overview of the optical joint 200 is now given followed by a detailed description of its components and use. The optical joint 200 includes one or more entrances 202, which are hereinafter called base ports 202 that connect through a base 204. The base 204 connects to a frame support 206 for supporting a frame 208 onto which a plurality of trays 210 and tray bases 212 are mounted. A routing device 100 is also mounted onto the frame 208 in a position adjacent to the frame support 206 and the base 204.

The optical joint 200 receives the cable elements through the base ports 202 and the base 204. Once the cable elements have been inserted into the optical joint 200, a length of each cable element is determined such that the optical fibres within the cable element can be routed to their respective tray 210. The optical fibres within each cable element are then split out. The length of the cable element is that required to reach the cable ports 102 of the routing device 100. The length of the optical fibres is that required to reach the optical fibre's corresponding tray 210.

The routing device 100 is mounted to frame 208 by either a snap fit joint or, if required, it can be more securely fastened by screws allowing greater strains to be sustained on the cable elements and routing device 100. In addition, to prevent possible strains on the cable elements to be transmitted to the routing device 100, a strain connector (not shown) or securing mechanism (not shown) is used to secure the cable element to the base 204 and base ports 202.

As described before in relation to FIGS. 1a, 1b and 1c, the cable elements are plugged into the cable ports 102 of the routing device 100 and the lengths of optical fibre are laid into the guiding tracks 104 through the output port 106 and, finally, the optical fibres are distributed to their corresponding trays 210. The routing device 100 provides a means for effectively controlling the routing, distribution, and protection of the optical fibres within the optical joint 200.

As shown in FIGS. 2a and 2b, the trays 210 are pivotally mounted by a pivoting mechanism 214 onto tray bases 212. The tray bases 212 are mounted onto the frame 208. Preferably, the tray bases are mounted by a snap-fit for easy installation and maintenance. The trays 210 are mounted such that they at least partially overlap each other and each tray is accessed by flipping or pivoting the trays above it. The inclined facet 110 of the routing device 100 not only provides a support for the trays 210 but also maximises the number of pivotally mounted trays 210 within the optical joint 200. The facet 110 also minimises the size of the optical joint 200 by allowing the trays 210 to be stored in a streamlined inclined position.

Referring to FIG. 2c, a perspective view of the optical joint 200 as described with reference to FIGS. 2a and 2b is shown with a cap 216. The cap 216 mates with the base 204 of the optical joint 200. The cap 216 encloses the components of the optical joint 200 and protects them from external environment.

The optical joint 200 would be weatherproofed by providing the cap 216 with a seal to prevent water and other environmental dirt entering the optical joint 200. The cap 216 is secured to the optical joint 200 by a securing mechanism (not shown), e.g. a screw thread, latches or clips. The optical joint 200 would be further sealed using a waterproof sealant, e.g. a silicon based sealant.

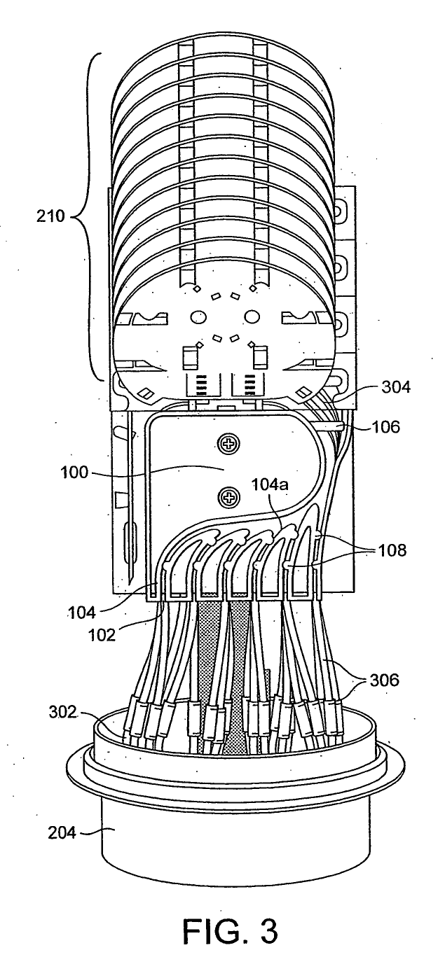

Referring to FIG. 3, a perspective view of the optical joint 200, as previously described, is shown using the embodiment of the routing device 100 as illustrated in FIG. 1c. The optical fibre cables 302 are received by the optical joint 200 and after entering the base 204 and base ports (not shown) the optical fibres 304 are split out of the optical fibre cables 302. Each optical fibre cable 302, and the optical fibres 304 thereinto, have a transport tube 306 that fits over the optical fibre cable and optical fibres. The transport tube 306 is fitted over the optical fibre cable, and can be elastically sealed. The transport tubes 306 are plugged into the cable ports 102 of the routing device 100 and the optical fibres 304 are then routed, as previously described, through the routing device 100 and distributed from the output port 106 to their respective trays 210. According to this embodiment, the routing device 100 is mounted with screws onto frame 208 and the trays 210 are pivoted in the direction away from the routing device 100.

It can be noted that the cable elements are controlled from the point of entry, i.e. from the base ports 202 and base 204, of the optical joint 200 up to the routing device 100 and then to the trays 210. The routing device 100 is arranged within the optical joint 200 such that the one or more cable elements are held substantially straight between at least one of the cable ports 102 of at least one of the arranged routing devices 100 and the base ports 202.

The optical fibre cables 302 come up from the base 204 and are directed substantially straight into the cable ports 102 of the routing device 100. Only a short length of transport tube 306 is required between the base 204 and the routing device 100, ensuring the optical fibres 304 within each transport tube 306 are kept substantially straight and not bent beyond their minimum bend radius.

This provides improved cable management of the cable elements as they are held substantially straight between the cable ports 102 of the arranged routing device 100 and the base ports 202 of the optical joint 200. By ensuring the cable elements are substantially straight, the optical fibres 304 within are also, in turn, held substantially straight. This further protects the optical fibres 304 from damage caused by intertwined cable elements or by bending the cable elements beyond their minimum bend radius as they are installed within the optical joint 200.

The routing device 100 allows for improved cable management as the optical cables 302, transport tubes 306, and optical fibres 304 are controlled and directed through the optical joint 200. The result is a minimisation of optical cable/fibre congestion within the optical joint 200 and a lower probability of damaging the optical fibres 304 during installation and maintenance.

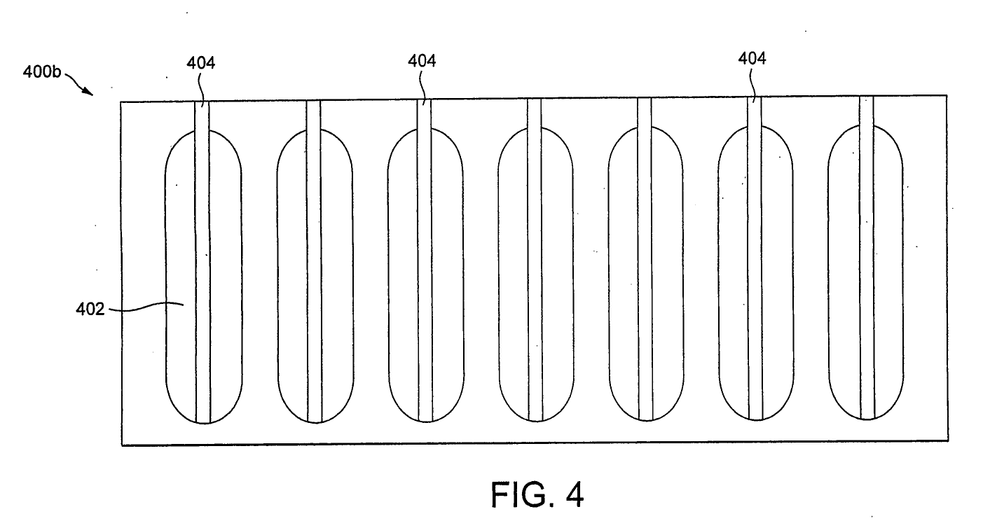

Referring to FIG. 4, a front elevation 400b of an embodiment of the routing device 100 is shown. In this case, there are six cable ports 402 capable of holding one or more cable elements. Instead of the cable ports 402 being circular in shape, they are elongated in shape. This allows more cable elements and/or different sized cable elements to be plugged into the cable ports 402.

The invention is not limited to optical joints. In fact, the invention can apply to further optical fibre hardware systems, such as racks or cabinets. These can be enclosures for patch and/or splice panels. Splice panels connect individual fibres from cables and patch panels provide a centralized location for patching fibres, testing, monitoring and restoring cables. Cable management is required even in these enclosures to minimise the congestion of, and likelihood of damage to, the optical cables and fibres stored and routed within.

1-31. (canceled)

32. A routing device for use in optical systems comprising:
a plurality of cable ports for at least partially receiving one or more cable elements, wherein the cable elements comprise one or more optical fibres;
a plurality of guiding tracks, each connected to at least one of the cable ports; and
at least one output port connected to at least one of the guiding tracks,
wherein the guiding tracks route the one or more optical fibres from their respective cable ports to the at least one output port for further distribution of the optical fibres.

33. The routing device of claim 32, wherein one or more holding portions are arranged to hold the optical fibres within their respective guiding tracks.

34. The routing device of claim 32, wherein two or more of the guiding tracks connect with at least one output port.

35. The routing device of claim 32, wherein the cable elements are designed to engage the cable ports, and the guiding tracks are designed to route the optical fibres split out from the cable elements.

36. The routing device of claim 32, further comprising one or more cable elements engaged in their respective cable ports, and optical fibres split-out from the cable elements, the optical fibres being routed in respective guiding tracks.

37. The routing device of claim 36, wherein the cable elements further comprise one or more tube elements that fit over the respective cable element and the corresponding optical fibres.

38. A routing device for use in optical systems comprising:
a plurality of cable ports for at least partially receiving one or more cable elements;
a plurality of guiding tracks, each connected to at least one of the cable ports; and
one or more output ports, wherein two or more of the guiding tracks connect with one of the output ports.

39. The routing device of claim 32, wherein the cable ports further comprise one or more gripping portions for gripping the cable elements.

40. A routing device for use in optical systems comprising:
a plurality of cable ports for at least partially receiving one or more cable elements; and
a plurality of guiding tracks, each connected to at least one of the cable ports,
wherein the cable ports further comprise one or more gripping portions for gripping the cable elements so that they are substantially straight in the region of the cable ports.

41. The routing device of claim 40, wherein the cable elements are held substantially straight before the entrance of their respective cable ports.

42. The routing device of claim 40, wherein two or more of the guiding tracks connect with at least one output port.

43. The routing device of claim 40, wherein at least one of the gripping portions further comprises ribs on the inner surface of the cable ports.

44. The routing device of claim 40, wherein at least one of the gripping portions further comprises barbs facing inward of their respective cable ports.

45. The routing device of claim 40, wherein at least one holding portion is arranged on at least one of the guiding tracks.

46. The routing device of claim 40, wherein at least one of the holding portions further comprises one or more tabs.

47. The routing device according to claim 32, wherein the guiding tracks have a width that is less than the width of their respective cable ports at their connection to the cable ports.

48. The routing device according to claim 32, wherein at least two of the guiding tracks merge together to form a guiding track having a width larger than one of the at least two guiding tracks.

49. The routing device according to claim 32, wherein at least one of the guiding tracks has at least one curved portion between their respective cable ports and at least one of the output ports.

50. The routing device of claim 49, wherein the at least one curved portion of the guiding tracks has a bend radius greater than the minimum bend radius of one or more optical fibres.

51. The routing device of claim 32, wherein the plurality of cable ports are arranged in a line.

52. The routing device of claim 32, wherein the plurality of cable ports are arranged in a plurality of parallel lines.

53. A method for routing optical fibres in an optical system using at least one routing device in accordance with claim 32, comprising:
splitting out one or more optical fibres from one or more cable elements;
inserting one or more cable elements into at least one cable port;
positioning one or more of the split-out optical fibres within one or more guiding tracks that are connected to the at least one cable port; and
guiding the one or more split-out optical fibres from the at least one cable port along the corresponding guiding tracks that are connected to at least one of the output ports for further distribution of the split-out optical fibres.

54. The method of claim 53, wherein the split-out optical fibres are guided within their corresponding guiding tracks such that the split-out optical fibres are positioned to allow one or more holding portions to hold the split-out optical fibres within the guiding tracks.

55. The method of claim 54, wherein, when at least one of the holding portions is a tab, then the corresponding split-out optical fibres are positioned under the tab.

56. The method of claim 53, wherein, as the split-out optical fibres are positioned, they are bent above their respective minimum bend radii.

57. The method according to claim 53, wherein at least one of the split-out optical fibres is positioned adjacent to a previously positioned split-out optical fibre.

58. An optical joint for use in optical systems comprising:
one or more trays for joining optical fibres; and
at least one routing device in accordance with claim 32, mounted within the optical joint.

59. The optical joint of claim 58, wherein at least one of the routing devices is arranged within the optical joint such that the one or more cable elements are held substantially straight between the one or more cable ports of at least one of the routing devices and at least one entrance for the cable elements to the optical joint.

60. The optical joint of claim 58, wherein the trays overlap each other.

61. The optical joint of claim 58, wherein the trays are hingedly mounted.

62. The optical joint of claim 58, wherein a cap is secured to the optical joint to enclose the components of the optical joint.
